(19) United States
(12) Patent Application Publication
(10) Pub. No.: US 2002/0166727 A1
(43) Pub. Date: Nov. 14, 2002

(54) Non-conducting ladder

(76) Inventors: Samuel C. Cramer, Florence, SC (US); Anthony Jay Cook, Florence, SC (US)

Correspondence Address: Joseph T. Guy, Ph.D., NEXSEN PRUET JACOBS & POLLARD, LLC, P.O. Box 10107, Fed. Sta., Greenville, SC, 29603-0107, US

(21) Appl. No.: 09/851,752

(22) Filed: May 9, 2001

(51) Int. Cl. E06C 7/00

(52) U.S. Cl. 182/228.1

(57) ABSTRACT

A non-conducting ladder which is light weight, structurally stable and economical is described. The non-conducting ladder comprises a first right stile and a first left stile. A first rung is attached to both the first right stile and the first left stile thereby forming a ladder segment. The non-conducting ladder also comprises second right stile and a second left stile. A first non-conducting connector attaches the first right stile and the second right stile. A second non-conducting connector attaches the first left stile and the second left stile.

### TECHNICAL FIELD

The present invention is related to a safety-ladder which does not conduct electricity. More specifically, this invention is related to a ladder with electrical conduction barriers incorporated therein.

### BACKGROUND

The use of ladders is well known. Ladders are typically constructed of wood; metals, such as aluminum; or composites. Wood ladders are known to be heavy and therefore they have largely been replaced by ladders constructed of aluminum and composites. Composite ladders are also heavy and subject to warping and the like which is undesirable. Metal ladders, particularly aluminum ladders, are by far the preferred ladder with regards to structural integrity and weight yet they are undesirable for use under conditions which may place the ladder in contact with electrical wires.

Heretofore, composite and wood ladders have been the choice in situations where electrical contact is anticipated. Metal ladders have been the choice when electrical contact is not anticipated. Unfortunately, a ladder coming into contact with an electrical wire often occurs by accident. Therefore, electrical shock still occurs. This problem is exacerbated by the realization that the light weight of metal ladders encourages their occasional use even when electrical safety is a concern. Furthermore, many users do not have the luxury to purchase multiple ladders and typically will choose a lightweight metal ladder for all uses without considering electrical safety. In spite of a reasonable solution, i.e. proper ladder selection, the problem of electrocution while using a ladder is still a major concern.

There has been a desire in the art for a ladder with the strength to weight relationship afforded by metal ladders and the non-conducting properties afforded by composite or wooden ladders. This desire must be met without sacrificing strength as would be readily apparent to one of even minimal knowledge of the art.

### SUMMARY

It is an object of the present invention to provide a ladder which is lightweight, and which does not conduct electricity.

It is another object of the present invention to provide a ladder with structural integrity which is suitable for a wide variety of uses.

Yet another object of the present invention is to provide a ladder which does not conduct electricity over its length, has acceptable structural integrity and a reasonable cost.

These and other advantages, as will be realized, are provided in a non-conducting ladder. The non-conducting ladder comprises a first right stile and a first left stile. A first rung is attached to both the first right stile and the first left stile thereby forming a ladder segment. The non-conducting ladder also comprises a second right stile and a second left stile. A first non-conducting connector attaches the first right stile and the second right stile. A second non-conducting connector attaches the first left stile and the second left stile.

Another embodiment is provided in a ladder comprising a first section and a second section. The first section comprises a pair of stile segments arranged in a coplanar relationship and at least one rung connected there between. The second section comprises a second pair of stile segments arranged in a coplanar relationship and at least one second rung connected there between. A non-conducting connector is situated between the first section and the second section.

Yet another embodiment is provided in a safety ladder. The safety ladder comprises a pair of stiles in coplanar relationship. A first rung is connected between the pair of stiles. A second rung is also connected between the pair of stiles parallel to the first rung. A non-conducting section is integral to the pair of stiles between the first rung and the second rung.

### BRIEF DESCRIPTION OF THE DRAWINGS

FIG. 1 is a view of an embodiment of the present invention.

FIG. 2 is a view of another embodiment of the present invention.

FIG. 3 is a partial side view taken along line 3-3 of FIG. 1.

FIG. 4 is an exploded view of the assembly of one embodiment of the non-conducting ladder.

FIG. 5 is an exploded view of the assembly of one embodiment of the non-conducting ladder.

FIG. 6 is an exploded view, in partial cut-away, illustrating one embodiment of the assembly of a non-conducting ladder.

### DETAILED DESCRIPTION

The invention will be described with reference to the drawings wherein similar elements are numbered accordingly.

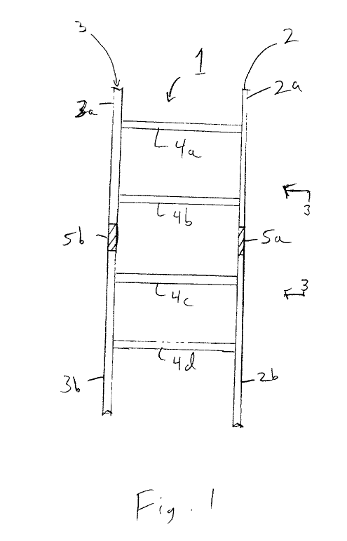

An embodiment of the inventive non-conducting ladder is illustrated in FIG. 1. The ladder, generally represented at 1, comprises a right stile, 2, and a left stile, 3, which form the basic support structure of a ladder. Each stile comprises stile segments which are indicated by letters. Bridging the stiles are rungs, 4. In the common use of the ladder the stiles are placed at an angle against an object, such as a wall, and the user climbs the rungs to reach the desired height. Each stile comprises at least one non-conducting barrier, 5, which eliminates electrical conduction between the stile segments. By way of example, non-conducting barrier, 5a, would not allow electrical conduction between stile segment, 2a, and stile segment, 2b. It would be apparent that non-conducting barrier, 5b, works accordingly such that the upper portion of the ladder is electrically isolated from the lower portion of the ladder. In the embodiment illustrated in FIG. 1, a ladder which comes in to contact with an electrical source at rung 4a, for example, will not conduct the electrical charge to rung 4c. Furthermore, the electrical charge will not dissipate to ground thereby reducing the possibility of sparks being generated. It would be apparent that non-conducting barriers are preferably between consecutive rungs to avoid a conduction circuit which utilizes rungs.

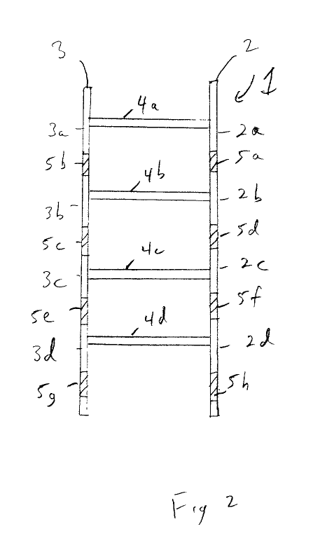

An embodiment of the inventive non-conducting ladder is illustrated in FIG. 2. In FIG. 2 each stile comprises a multiplicity of stile segments each separated by non-conducting barriers, 5. If any portion of the ladder comes into contact with an electrical source the conduction of electricity will be isolated to a single rung section, defined as the tile segments and associated rung, and will not be propagated further. By way of example, if the ladder comes into contact with an electrical source at the section comprising rung 4a, stile segment 2a and stile segment 3a, the electricity would not be conducted to rung 4b since non-conducting barriers 5a and 5b would prohibit such conduction. Therefore, if a person were standing on rung 4d and holding rung 4b they would not be effected by the contact with the electrical source at rung 4a.

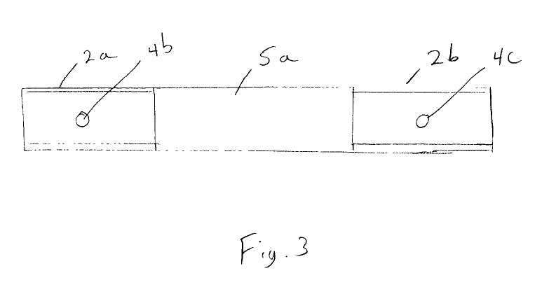

FIG. 3 is a side view taken along line 3-3 of FIG. 1. In FIG. 3 the stile segment, 2a, and stile segment, 2b, are separated physically and electrically by the non-conducting barrier, 5a. The rungs, 4b and 4c, protrude through, and are attached to, the stile as well known in the art of ladder manufacture.

The manner in which the non-conducting barrier and stile segments are connected is limited by the necessity to insure that electrical conductivity is essentially eliminated and by the structural requirements for the size ladder being manufactured.

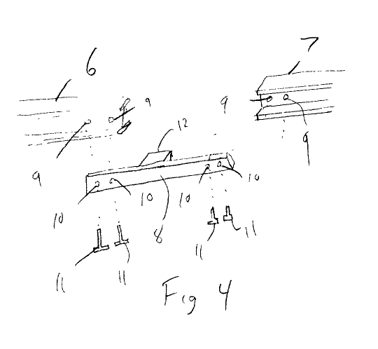

A method of connecting the non-conducting barrier to the respective stile segments is illustrated in exploded view in FIG. 4. In FIG. 4 a first stile segment, 6, and second stile segment, 7, are both attached to a non-conducting brace, 8. The non-conducting brace is in the form of a rectangle. Each stile comprises at least one securing void, 9, which aligns with a mounting void, 10, of the non-conducting brace, 8. An attachment element, 11, such as a rivet, pin, threaded member, or the like is received by the mounting void, 10, and securing void, 9, to secure the non-conducting brace to each stile segment. The securing void and mounting void are spaced such that the stile segments are not physically in contact and are separated enough to prohibit electrical conductivity. An optional non-conducting spacer, 12, allows the stile segments to be abutted there against to increase structural integrity. In a particularly preferred embodiment a pair of non-conducting braces are employed wherein the stile segments are sandwiched there between with an air space, or non-conducting spacer, between the stile segments to prohibit conduction of electricity. The non-conducting brace is also referred to as a non-conducting connector.

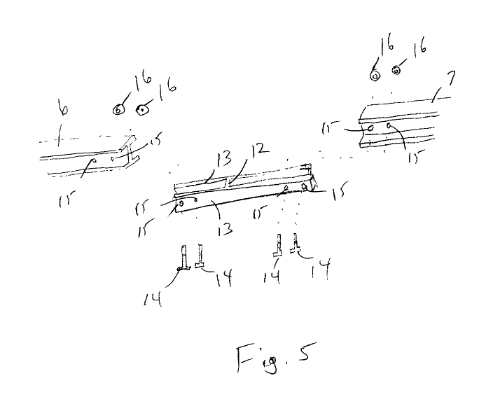

Another embodiment of the present invention is provided in FIG. 5. In FIG. 5, a first stile segment, 6, and second stile segment, 7, have a preferred non-conducting spacer, 12, there between. The non-conducting barrier has securing arms, 13, integral thereto which form a sandwich with the stiles. Optional, but preferred, attachment elements, 14, are received by matching voids, 15, to draw the securing arms and stile segments into close proximity. The attachment elements, 14, may be externally threaded members, such as a bolt, with mating internally threaded members, 16, such as a nut. Alternatively, the attachment elements may be rivets, pins, or the like. It is contemplated that the securing arms and stile segments may be secured one to the other with adhesives or with friction created by a very small difference between the thickness of the stile segment and the size of the opening, or throat, formed by the opposing securing arms. It is also contemplated that one or both of the securing arms and stile segment may comprise protrusions which create friction or interlock to secure the securing arms to the stile. It is also contemplated that the securing arms are forced apart by the stile and spring-like action maintains the stile in tight relationship within the securing arms. The non-conducting spacer, 12, and securing arms, 13, taken together form a connector.

As would be apparent from the description herein the securing arms illustrated in FIG. 5 are non-conducting. The securing arms and non-conducting spacer may be separate elements or they may be integral. In a most preferred embodiment the securing arms and non-conducting spacer are integral.

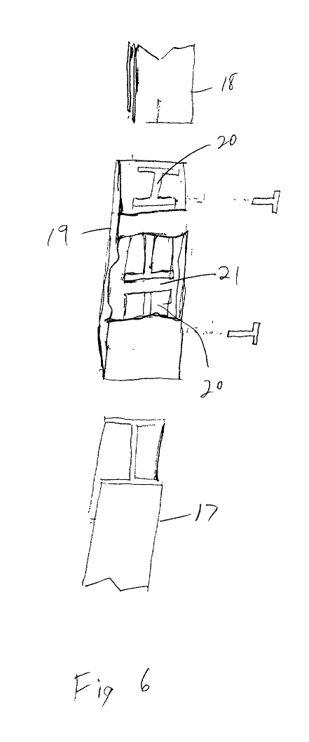

An embodiment of the present invention is shown in partial cut-away exploded view in FIG. 6. In FIG. 6 a lower stile segment, 17, and upper stile segment, 18, are connected by a non-conducting connector, 19. The lower stile and upper stile comprise a cross-sectional shape. In the embodiment illustrated the cross-sectional shape is similar to an “I” and is commonly referred to as an I-beam. Other cross-sectional shapes could be employed as well known in the art including rectangular, circular, oblong, “J”, “T” or any other cross-sectional shape typically employed in the art of ladder manufacture. The non-conducting connector comprises a void, 20, which is shaped to receive the stile segment. In a particularly preferred embodiment the void has the same shape as the cross-sectional shape of the stile segment and is only slightly larger such that the stile can be received therein with slight force. An optional, but preferred, barrier, 21, separates the void into compartments wherein the upper stile segment, 18, and lower stile segment, 17, are separated thereby insuring that there is no electrical conductivity there between.

The exterior shape of the non-conducting connector is not limiting. In FIG. 6 the exterior shape is shown as a rectangle. The exterior shape is chosen for strength and aesthetics and may have the same shape as the void therein or it may comprise faces which can incorporate logos, pictures, instructions of use, warnings and the like.

Optional, but preferred attachment members, 22, received by matching voids, not shown, can be used to secure the non-conducting connector to the stiles. In an embodiment of the invention the attachment members can secure the stiles to the non-conducting connector without the necessity for a barrier, 21, since the stiles will be separated and secured in a non-contacting configuration.

The non-conducting ladder is specifically designed to eliminate electrical conductivity between sections of the ladder. Specifically, the non-conducting ladder is designed such that an electrical charge on one section will not reach a second section. In a particularly preferred embodiment, the non-conducting ladder has multiple non-conducting connectors such that electrical charge is isolated to a discrete section of the ladder. For the sake of the present invention the non-conducting ladder is defined to have stile segments which have a resistance of no more than 10 Ωm but the resistance between sections is at least 10⁸ Ωm. More preferably, the non-conducting ladder has a resistance of at least 10 Ωm as measured from one stile segment to a second stile segment separated by a non-conducting connector.

The manner in which the stile segments and non-conducting connector are attached depends on the expected use. A longer ladder, would necessarily require more strength. For a longer ladder an attachment element such as a rivet, pin or threaded nut and bolt is preferred. A shorter ladder requires less strength and therefore a friction based connection can be employed. It is also contemplated to use ladder segments and connectors for a modular ladder with a length which varies by the number of segments employed.

The non-conducting barrier, or connector, is preferably manufactured from a material which can be extruded or pultruded. Particularly preferred materials include fiberglass, plastic, reinforced plastic, and the like.

The stile and rung is preferably manufactured from metal. The most preferred metal comprises aluminum, magnesium, titanium, steel and alloys thereof.

The stile preferably has a cross-sectional shape including rectangular, circular, oblong, “I”, “J”, “T” or any other cross-sectional shape typically employed in the art of ladder manufacture.

It is contemplated that additional non-conducting connectors could be utilized in the rungs such that each rung comprises two rung segments with a non-conducting connector there between.

Stiles and stile segments are preferably coplanar and may be parallel with the rungs perpendicular to both stiles. Stiles may also be further apart on one end then the other to increase stability.

The present invention can be utilized with any ladder commonly employed in the art. Specifically contemplated are extension ladders wherein one section moves parallel to the other section. For extension ladders the non-conducting connectors can be located in either section or both sections. It is preferable to have a sufficient number and locations to prohibit electrical charge from conducting from one ladder section to the other ladder section. Step ladders can be employed with non-conducting connectors in either side or at a common location such as at the top.

Rungs are typically flat, round or rounded with a flat section on one side for traction. The manufacture of rungs and attachment of rungs to a stile, or stile segment, is well known in the art of ladder manufacturing and further elaboration herein is not necessary.

The invention has been describe with emphasis directed to the preferred embodiments. It would be apparent from the description herein that various embodiments could be developed without departing from the scope of the invention. Alternate methods of construction, operation and use could also be employed without departing from the scope of the invention which is set forth in the claims which follow.

1. A non-conducting ladder comprising:
a first right stile; and
a first left stile;
a first rung attached to said first right stile and said first left stile;
a second right stile; and
a second left stile;
a first non-conducting connector attached to said first right stile and said second right stile; and
a second non-conducting connector attached to said first left stile and said second left stile.

2. The non-conducting ladder of claim 1 further comprising a second rung attached to said second right stile and said second left stile.

3. The non-conducting ladder of claim 2 wherein said first rung and said second rung are consecutive.

4. The non-conducting ladder of claim 3 wherein said first non-conducting connector is between said first rung and said second rung.

5. The non-conducting ladder of claim 1 wherein said first connector comprises a non-conducting spacer in contact with said first right stile and said second right stile.

6 The non-conducting ladder of claim 1 wherein said first connector comprises a first void for receiving said first right stile and a second void for receiving said second right stile.

7. The non-conducting ladder of claim 1 wherein said first right stile and said second right stile are approximately co-linear.

8. The non-conducting ladder of claim 1 comprising a multiplicity of rungs attached to said first right stile and said first left stile.

9. A ladder comprising:
a first section comprising a pair of stile segments arranged in a coplanar relationship and at least one rung connected there between;
a second section comprising a second pair of stile segments arranged in a coplanar relationship and at least one second rung connected there between; and
a non-conducting connector between said first section and said second section.

10. The ladder of claim 9 wherein said non-conducting connector comprises at least one void for receiving at least one of said pair of stile segments.

11. The ladder of claim 10 wherein said non-conducting connector comprises a first connector and a second connector each capable of receiving a stile of said pair of stiles.

12. The ladder of claim 9 wherein said first section and said second section are co-planar.

13. The ladder of claim 9 wherein said first section comprises a multiplicity of rungs.

14. A ladder comprising:
a pair of stiles in coplanar relationship;
a first rung connected between said pair of stiles;
a second rung connected between said pair of stiles and parallel to said first rung; and
a non-conducting section integral to said pair of stiles between said first rung and said second rung.

15. The ladder of claim 14 wherein said non-conducting section comprises a spacer.

16. The ladder of claim 14 wherein said pair of stiles comprises:
a first stile comprising a first stile segment and a second stile segment; and
a second stile comprising a third stile segment and a fourth stile segment.

17. The ladder of claim 16 wherein said non-conducting section comprises a non-conducting connector between said first segment and said third segment.

18. The ladder of claim 17 wherein said non-conducting connector comprises a first void for receiving said first segment.

19. The ladder of claim 18 wherein said non-conducting connector comprises a second void for receiving said third segment.

20. The ladder of claim 19 further comprising a spacer between said first void and said second void.
